(19) United States
(12) Patent Application Publication
(10) Pub. No.: US 2026/0079750 A1
(43) Pub. Date: Mar. 19, 2026

(54) DYNAMIC COMPUTER SELECTION FOR QUANTUM WORKLOAD EXECUTION

(71) Applicant: Red Hat, Inc., Raleigh, NC (US)

(72) Inventors: Leigh Griffin, Waterford (IE); Stephen Coady, Dublin (IE)

(21) Appl. No.: 18/825,545

(22) Filed: Sep. 5, 2024

(51) Int. Cl. G06F 9/50; G06N 10/20

(52) U.S. Cl. CPC G06F 9/5027; G06N 10/20

(57) ABSTRACT

A computing system receives a request to execute a quantum workload. The computing system is in communication with a plurality of quantum computing systems (QCSs) operable to initiate the quantum workload upon request, and in communication with a plurality of classical computing systems operable to initiate a quantum simulation of the quantum workload. Based at least in part on information associated with the request, a determination is made to cause initiation of the quantum workload on a particular QCS or in a quantum simulator on a classical computing system. Based on the determination, the quantum workload is caused to be initiated on the particular QCS of the plurality of QCSs, or a quantum simulator is caused to be initiated on the classical computing system of the plurality of classical computing systems, and the quantum workload is caused to be initiated in the quantum simulator.

### BACKGROUND

A quantum workload, such as a quantum instruction file that implements quantum operations on a qubit, may be executed on a quantum computing system, or may be executed in a quantum simulator that runs on a classical computing device.

### SUMMARY

The examples disclosed herein implement dynamic computer selection for quantum workload execution.

In one example a method is provided. The method includes receiving, by a computing system comprising one or more computing devices, a first request to execute a first quantum workload, wherein the computing system is in communication with a plurality of quantum computing systems (QCSs) operable to initiate the first quantum workload upon request, and in communication with a plurality of classical computing systems operable to initiate a quantum simulation of the first quantum workload. The method further includes, based at least in part on information associated with the first request, making a determination to cause the initiation of the first quantum workload on a particular QCS of the plurality of QCSs or in a quantum simulator on a classical computing system of the plurality of classical computing system. The method includes based on the determination, causing, by the computing system, the first quantum workload to be initiated on the particular QCS of the plurality of QCSs or causing, by the computing system, the quantum simulator to be initiated on the classical computing system of the plurality of classical computing systems and causing the first quantum workload to be initiated in the quantum simulator.

In another example a computing system is provided. The computing system includes one or more computing devices to receive a first request to execute a first quantum workload, wherein the computing system is in communication with a plurality of QCSs operable to initiate the first quantum workload upon request, and in communication with a plurality of classical computing systems operable to initiate a quantum simulation of the first quantum workload. The one or more computing devices are further to, based at least in part on information associated with the first request, make a determination to cause the initiation of the first quantum workload on a particular QCS of the plurality of QCSs or in a quantum simulator on a classical computing system of the plurality of classical computing system. The one or more computing devices are further to, based on the determination, cause the first quantum workload to be initiated on the particular QCS of the plurality of QCSs or cause the quantum simulator to be initiated on the classical computing system of the plurality of classical computing systems and causing the first quantum workload to be initiated in the quantum simulator.

In another example a non-transitory computer-readable storage medium is provided. The non-transitory computer-readable storage medium includes executable instructions to cause one or more computing devices to receive a first request to execute a first quantum workload, wherein the computing system is in communication with a plurality of QCSs operable to initiate the first quantum workload upon request, and in communication with a plurality of classical computing systems operable to initiate a quantum simulation of the first quantum workload. The instructions further cause the one or more computing devices to, based at least in part on information associated with the first request, make a determination to cause the initiation of the first quantum workload on a particular QCS of the plurality of QCSs or in a quantum simulator on a classical computing system of the plurality of classical computing system. The instructions further cause the one or more computing devices to, based on the determination, cause the first quantum workload to be initiated on the particular QCS of the plurality of QCSs or cause the quantum simulator to be initiated on the classical computing system of the plurality of classical computing systems and causing the first quantum workload to be initiated in the quantum simulator.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIGS. 1A-1E are block diagrams of an environment in which dynamic computer selection for quantum workload execution can be implemented according to some examples;

FIG. 2 is a flowchart of a method for dynamic computer selection for quantum workload execution according to some examples;

FIG. 3 is a simplified block diagram of the environment illustrated in FIGS. 1A-1E according to some implementations; and

FIG. 4 is a block diagram of a computing device suitable for implementing examples according to one example.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples and claims are not limited to any particular sequence or order of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

A quantum workload, such as a quantum instruction file that implements quantum operations on a qubit, may be executed on a quantum computing system, or may be executed in a quantum simulator that runs on a classical computing device. While it may be desirable to execute a quantum workload on a quantum computing system, there may be situations where it would be suitable, such as if a quantum computing system were not currently available or due to other conditions and/or constraints, to execute the quantum workload in a quantum simulator.

The examples disclosed herein implement dynamic computer selection for quantum workload execution. A computing system receives a request to execute a quantum workload. The computing system is in communication with a plurality of individual quantum computing systems (QCSs) that are operable to initiate a quantum workload upon request, and a plurality of classical computing systems operable to initiate a quantum simulation of a quantum workload. The computing system obtains information associated with the request and based at least in part on the information, causes the quantum workload to be initiated on a particular QCS of the plurality of QCSs or causes a quantum simulator to be initiated on a classical computing system of the plurality of classical computing systems and causes the quantum workload to be initiated in the quantum simulator. Among other advantages, the examples disclosed herein ensure efficient use of quantum computing systems and load-balancing between such quantum computing systems and quantum simulators executing on classical computing systems.

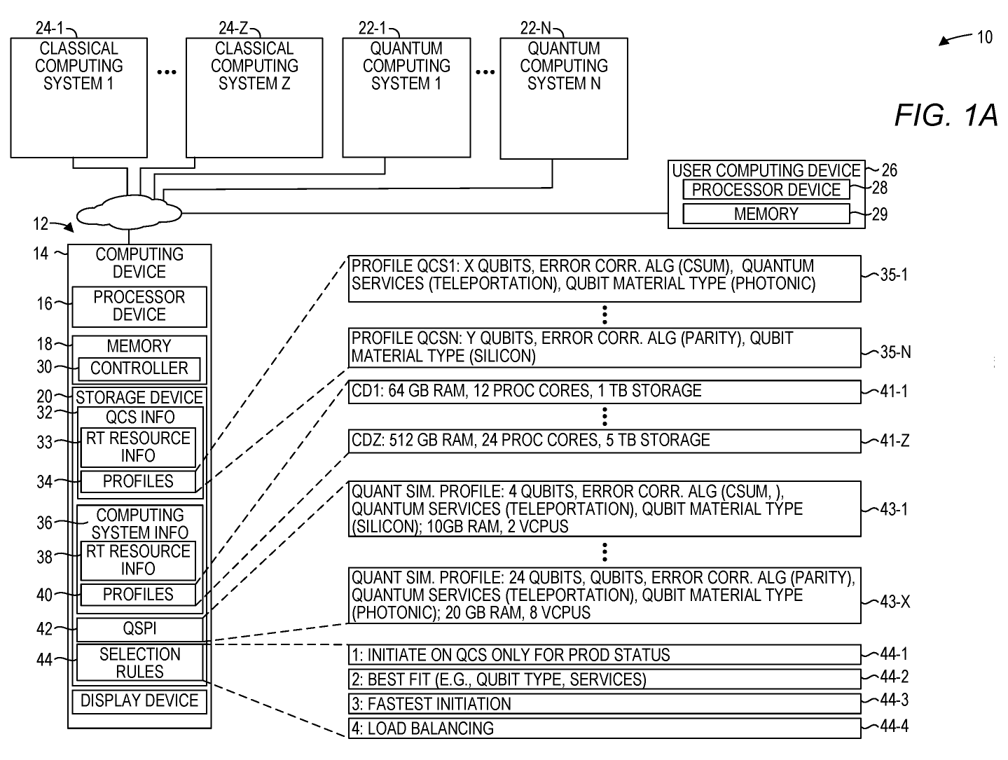

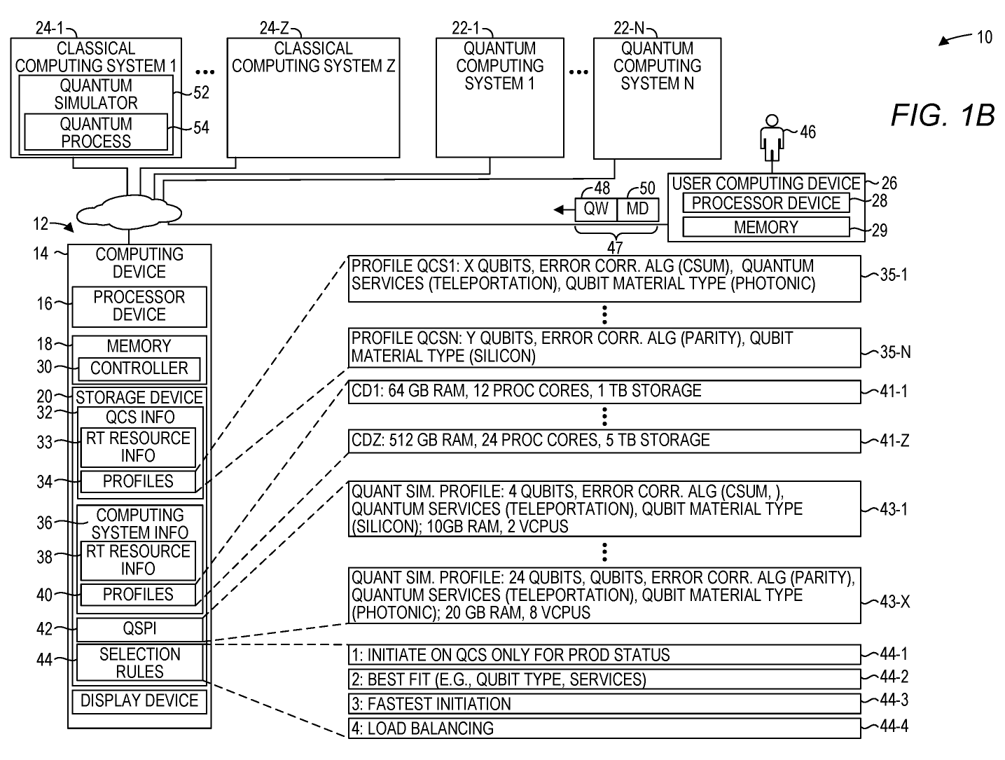

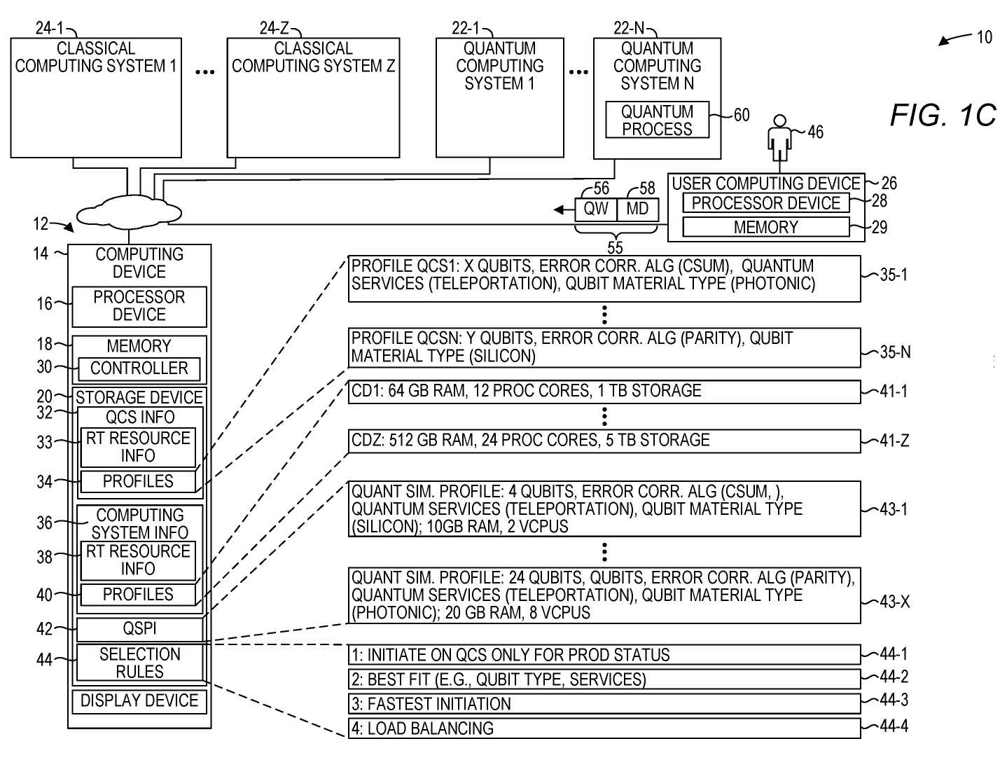

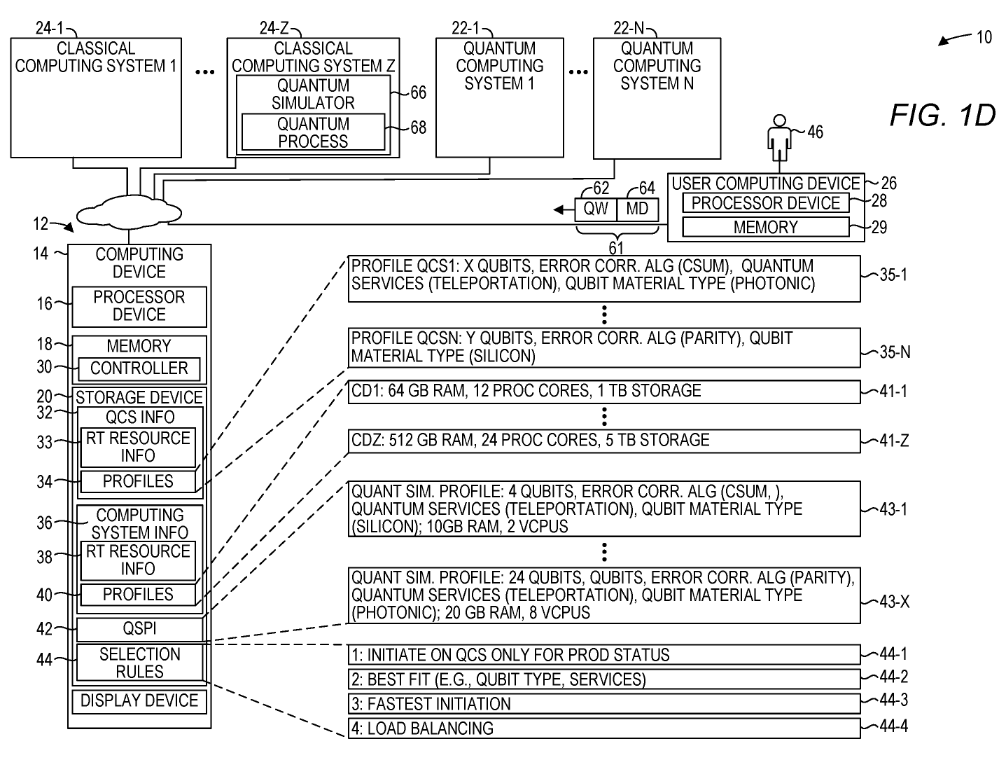

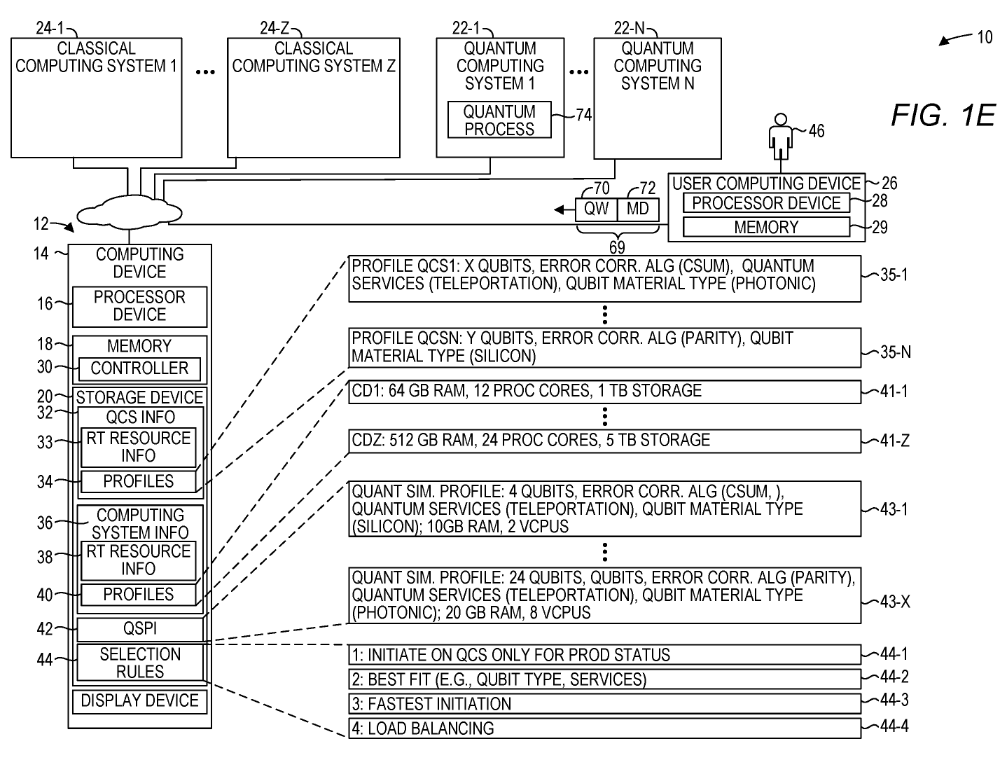

FIGS. 1A-1E are block diagrams of an environment 10 in which dynamic computer selection for quantum workload execution can be implemented according to some examples. Referring first to FIG. 1A, the environment 10 includes a computing system 12 that includes one or more computing devices 14. The computing device 14 includes a processor device 16 and a memory 18. The computing device 14 includes, or is communicatively coupled to, a storage device 20. The computing system 12 is in communication with a plurality of QCSs 22-1 – 22-N (generally, QCSs 22). Each of the QCSs 22 operate in a quantum environment but can operate using classical computing principles or quantum computing principles. When using quantum computing principles, a QCS 22 performs computations that utilize quantum-mechanical phenomena, such as superposition and entanglement. A QCS 22 may operate under certain environmental conditions, such as at or near 0° Kelvin. When using classical computing principles, a QCS 22 utilizes binary digits that have a value of either 1 or 0.

Each QCS 22 is operable to initiate a quantum workload upon request. The term “quantum workload” as used herein refers to a set of instructions that, when executed by a QCS 22 or a quantum simulator, implements (or simulates, respectively), quantum operations on a qubit. The set of instructions may be referred to herein as a quantum instruction file (QIF), and comport with the syntax of a quantum programming language, or comprise executable instructions derived from source instructions that comport with the syntax of a quantum programming language.

The computing system 12 is also in communication with a plurality of classical computing systems 24-1 – 24-Z (generally, computing systems 24). Each of the classical computing systems 24 include one or more processing devices and memories, and are operable to initiate a quantum simulation of a quantum workload. In some implementations the computing systems 24 may compose one or more public and/or private cloud computing environments.

The environment 10 includes one or more user computing devices 26 that are operable to submit, send, or otherwise provide a quantum workload to the computing system 12. Each of the computing devices 26 includes a processor device 28 and a memory 29.

The computing system 12 includes a controller 30 that is operable to implement certain functionality described herein. Because the controller 30 is a component of the computing system 12, functionality implemented by the controller 30 may be attributed to the computing system 12 generally. Moreover, in examples where the controller 30 comprises software instructions that program a processor device, such as the processor device 16, to carry out functionality discussed herein, functionality implemented by the controller 30 may be attributed herein to the processor device 16.

The storage device 20 includes QCS information 32 associated with the plurality of QCSs 22. The QCS information 32 identifies one or more of real time resource information 33 about the plurality of QCSs 22 and QCS configuration information 34 that identifies characteristics of the plurality of QCSs 22. The real time resource information 33 may include, for example, for each QCS 22, a current number of available qubits, a current quantity of available memory, a current error-correction rate, a current temperature, a current processor utilization, a current queue depth of quantum workloads to be initiated, or any other computing resource metric that may change over time.

The QCS configuration information 34 may identify, for example, a total quantity of qubits implemented on a particular QCS 22, error correction algorithms available on a particular QCS 22, a type of qubit implemented on a particular QCS 22, quantum services that are available on the QCS 22, and the like. In this example, the QCS configuration information 34 comprises a plurality of QCS profiles 35-1 – 35-N (generally, QCS profiles 35), each QCS profile 35 corresponding to a QCS 22. The QCS profile 35-1 corresponds to the QCS 22-1 and indicates that the QCS 22-1 has a total quantity of X qubits, uses a checksum error correction algorithm, has a teleportation quantum service, and implements photonic qubits. The QCS profile 35-N corresponds to the QCS 22-N and indicates that the QCS 22-N has a total quantity of Y qubits, uses a parity error correction algorithm, does not implement a teleportation quantum service, and implements silicon qubits.

The storage device 20 includes computing system information 36 that identifies characteristics of the computing systems 24. The computing system information 36 may include real time resource information 38 about the plurality of computing systems 24 and configuration information 40 that identifies characteristics of the plurality of computing systems 24. The real time resource information 38 may include, for example, for each computing system 24, a current processor utilization of the computing system 24, a current amount of available memory of the computing system 24, a current number of tasks being executed on the computing system 24, a current queue depth of quantum simulators to be initiated, or any other computing resource metric that may change over time.

The configuration information 40 may identify, for example, a total amount of random access memory (RAM) implemented on a particular computing system 24, a quantity of processor cores of a particular computing system 24, an amount of storage of a particular computing system 24, and any other provisioned computing resource quantity. In this example, the configuration information 40 comprises a plurality of profiles 41-1 – 41-Z (generally, profiles 41), each profile 41 corresponding to a computing system 24. The profile 41-1 corresponds to the computing system 24-1 and indicates that the computing system 24-1 has 64 GB of memory, has 12 processor cores, and 1 TB of data storage. The profile 41-Z corresponds to the computing system 24-Z and indicates that the computing system 24-Z has 512 GB of memory, has 24 processor cores, and 5 TB of data storage.

The storage device 20 includes quantum simulator profile information 42 that comprises a plurality of quantum simulator profiles 43-1 – 43-X (generally, quantum simulator profiles 43). Each quantum simulator profile 43 identifies simulated quantum computer resource characteristics of a quantum simulator initiated based on the respective quantum simulator profile 43. The quantum simulator profiles 43 may also identify characteristics of the classical computing system 24 on which a quantum simulator initiated from the quantum simulator profile 43 should have. As an example, a quantum simulator initiated based on the quantum simulator profile 43-1 implements 4 qubits, uses a checksum error checking algorithm, has a teleportation service, and implements silicon qubits. The quantum simulator profile 43-1 indicates that a classical computing system 24 used to initiate a quantum simulator from the quantum simulator profile 43-1 should have at least 10 GB of RAM and at least 2 virtual (e.g., if running in a virtual machine) or actual CPUs. A quantum simulator initiated based on the quantum simulator profile 43-X implements 24 qubits, uses a parity error checking algorithm, has a teleportation service, and implements photonic qubits. The quantum simulator profile 43-X indicates that a classical computing system 24 used to initiate a quantum simulator from the quantum simulator profile 43-X should have at least 20 GB of RAM and at least 8 virtual or actual CPUs.

The storage device 20 may also include one or more selection rules 44-1 – 44-4 (generally, selection rules 44) that may be used individually, or in combination, which the controller 30 can use to determine whether a quantum workload should be initiated on a quantum computing system 22 or in a quantum simulator initiated on a classical computing system 24. The selection rule 44-1 indicates that a quantum workload that does not have a production status will be initiated in a quantum simulator initiated on a classical computing system 24. The selection rule 44-2 is a best fit selection rule and indicates that a quantum workload is to be initiated on a best fit basis, wherein the controller 30 is to initiate a quantum workload on a QCS 22 of the plurality of QCSs 22 or simulated in a quantum simulator on a classical computing system 24 based on a closest matching configuration of computing resource needs of the quantum workload compared to the computing resource characteristics of the plurality of QCSs 24 as identified in the corresponding QCS profiles 35 and the quantum computer resource characteristics identified in the quantum simulator profiles 43.

The selection rule 44-3 is a fastest initiation selection rule indicating that the controller 30 is to initiate the quantum workload on a QCS 22 of the plurality of QCSs 22 or cause the quantum workload to be simulated in a quantum simulator on a classical computing system 24 based on where the quantum workload can be executed first.

The selection rule 44-4 is a load balancing selection rule indicating that the controller 30 is to initiate the quantum workload on a QCS 22 of the plurality of QCSs 22 or cause the quantum workload to be simulated in a quantum simulator on a classical computing system 24 based on the current load of the QCSs 22 and the computing systems 24.

The selection rules 44 may be configurable and may be prioritized. Each selection rule 44 may be enabled or disabled. For example, the selection rule 44-1 may be enabled and be assigned a first priority such that any quantum workload that has a status other than production is to be initiated in a quantum simulator on a classical computing system 24 and not on a QCS 22. The selection rule 44-2 may be enabled and assigned a second priority, and thus such quantum workload will be initiated in a quantum simulator on a classical computing system 24 based on the closest matching configuration of computing resource needs of the quantum workload compared to the quantum computer resource characteristics identified in a quantum simulator profile 43 of the plurality of quantum simulator profiles 43.

In another example, the selection rule 44-1 may be enabled and be assigned a first priority such that any quantum workload that has a status other than production is to be initiated in a quantum simulator on a classical computing system 24. The selection rule 44-3 may be enabled and assigned a second priority, and thus such quantum workload will be initiated in a quantum simulator on a classical computing system 24 based on which classical computing system 24 the quantum workload can be initiated first.

In another example, the selection rule 44-1 may be enabled and be assigned a first priority such that any quantum workload that have a status other than production is to be initiated in a quantum simulator on a classical computing system 24. The selection rule 44-4 may be enabled and assigned a second priority, and thus such quantum workload will be initiated in a quantum simulator on a classical computing system 24 based on a load balancing algorithm, such as a round-robin load balancing algorithm.

In another example, the selection rules 44-1, 44-3 and 44-4 may be disabled and the selection rule 44-2 may be enabled such that the controller 30 will initiate a quantum workload on a QCS 22 of the plurality of QCSs 22 or simulated in a quantum simulator on a classical computing system 24 based on a closest matching configuration of computing resource needs of the quantum workload compared to the computing resource characteristics of the plurality of QCSs 22 and the quantum computer resource characteristics identified in the quantum simulator profiles 42.

In another example, the selection rules 44-1, 44-2 and 44-4 may be disabled and the selection rule 44-3 may be enabled such that the controller 30 will initiate a quantum workload on a QCS 22 of the plurality of QCSs 22 or cause the quantum workload to be simulated in a quantum simulator on a classical computing system 24 based on where the quantum workload can be executed first.

In another example, the selection rules 44-1, 44-2 and 44-3 may be disabled and the selection rule 44-4 may be enabled such that the controller 30 will initiate a quantum workload on a QCS 22 of the plurality of QCSs 22 or cause the quantum workload to be simulated in a quantum simulator on a classical computing system 24 based on the current load of the QCSs 22 and the computing systems 24.

It is noted that the selection rules 44 disclosed herein are merely examples, and the implementations are not limited to any particular selection rule or rules.

With this background, and referring now to FIG. 1B, an example of dynamic computer selection for quantum workload execution will be discussed. In this example, a user 46 of the computing device 26 causes the computing device 26 to send a request 47 that includes a quantum workload 48 to the computing system 12 for initiation on a QCS 22 or initiation in a quantum simulator that is initiated on a computing system 24. The quantum workload 48 may comprise, for example, a quantum instruction file (QIF), such as a quantum assembly file or the like, written to comport with a quantum programming language. In some examples the quantum workload 48 may include, or be accompanied by, metadata 50 that comprises information about the quantum workload 48. The information may identify computing resource characteristics necessary for the quantum workload 48 to execute. The computing system 12 receives the request 47. The controller 30 obtains information about the request 47. The information can comprise the metadata 50, and/or the information can comprise information contained in the quantum workload 48. For example, the quantum workload 48 may comprise a QIF, and the controller 30 may parse the QIF to determine computing resource needs of the QIF. For example, the controller 30 may parse the QIF to determine a quantity of qubits needed by the QIF, to determine a qubit material type expected by the QIF. In some implementations, the QIF may be annotated using comments to identify a quantify of memory required, a quantity of actual or virtual CPUs required, a quantity of storage, quantum services, such as teleportation services, which are required, or any other physical characteristic of a quantum computing system that may be required to execute the quantum workload. Alternatively, such information may be included in the metadata 50. In this example, assume that the information indicates that the quantum workload 48 requires three qubits, a teleportation service, and a silicon qubit material.

In this example assume that the selection rule 44-1 is enabled and has a first priority, and that the selection rule 44-2 is enabled and has a second priority. The selection rules 44-3 – 44-4 are disabled. Further assume that the metadata 50 indicates that the quantum workload 48 does not have a production status. In response to determining that the selection rule 44-1 is enabled and that the quantum workload 48 does not have a production status the controller 30 determines that the quantum workload 48 is to be initiated on a classical computing system 24 of the plurality of classical computing systems 24. In response to determining that the selection rule 44-2 is enabled the controller 30 accesses the quantum simulator profiles 43-1 – 43-X to determine a closest matching configuration of computing resource needs of the quantum workload 48 compared to the computing resource characteristics identified in the quantum simulator profiles 43-1 – 43-X.

The controller 30 determines that the quantum simulator profile 43-1 most closely matches the computing resource needs of the quantum workload 48. The controller 30 may also perform a closest matching comparison between the classical computing device resource requirements identified in the quantum simulator profile 43-1 and the computing systems 24. In this example, the quantum simulator profile 43-1 indicates that 10 GB of RAM and 2 virtual or actual CPUs are required. The controller 30 determines, based on the profiles 41-1 – 41-Z that the profile 41-1 most closely matches the computing device resource requirements identified in the quantum simulation profile 43-1.

The controller 30 causes a quantum simulator 52 to be initiated on the classical computing 24-1 and causes the quantum workload 48 to be initiated as a quantum process 54 in the quantum simulator 52. The quantum simulator 52 may comprise any suitable quantum simulation technology, such as, by way of non-limiting example, Qiskit quantum simulation technology. In particular, the controller 30 may instruct the computing system 24-1, based on the quantum simulator profile 43-1, to initiate the quantum simulator 52 that has four qubits, a checksum error correction algorithm, a teleportation service, and a silicon qubit material type. The controller 30 may send the quantum workload 48 to the computing system 24-1 for initiation in the quantum simulator 52.

After the quantum process 54 terminates, the computing system 24-1 terminates the quantum simulator 52. The results of the quantum simulation may be stored in a predetermined location and subsequently accessed by the computing device 26. In this manner, the environment 10 need not initiate the quantum simulator 52 until the quantum simulator 52 is needed, and the quantum simulator 52 that is initiated is “right-sized” for the quantum workload 48 such that unnecessary resources of the computing system 24-1 are not allocated to the quantum simulator 52.

In another example of dynamic computer selection for quantum workload execution, assume that the selection rules 44-1, 44-3 and 44-4 are disabled and the selection rule 44-2 is enabled. The selection rule 44-2 is a best fit selection rule. A quantum workload is submitted to the controller 30. The controller 30 determines that the information submitted with the request, for example, either the metadata associated with the request or the quantum workload itself, identifies a characteristic of a QCS necessary for the quantum workload to execute. In this example, the characteristic is a particular quantum service R. The controller 30 accesses the QCS profiles 35-1 – 35-N and determines that no QCSs 22 of the plurality of QCSs 22 offer the quantum service R. The controller 30 accesses the quantum simulation profiles 43-1 – 43-X, and determines that a quantum simulation profile 43 does include the quantum service R. In response to determining that the quantum simulator profile 43 includes the quantum service R, the controller 30 causes a quantum simulator to be initiated on a classical computing system 24 of the plurality of classical computing systems 24 and causes the quantum workload to be initiated in the quantum simulator.

Referring now to FIG. 1C, another example of dynamic computer selection for quantum workload execution will be discussed. In this example, the user 46 of the computing device 26 causes the computing device 26 to send a request 55 comprising a quantum workload 56 to the computing system 12 for initiation on a QCS 22 or initiation in a quantum simulator that is initiated on a computing system 24. The quantum workload 56 includes, or is accompanied by, metadata 58 that comprises information about the quantum workload 56. The computing system 12 receives the quantum workload 56 and the metadata 58. The controller 30 obtains information about the request 55. Again, the information can comprise the metadata 58, and/or the information can comprise information contained in the quantum workload 56. For example, the quantum workload 56 may comprise a QIF, and the controller 30 may parse the QIF to determine computing resource needs of the QIF. In this example, assume that the information indicates that the quantum workload requires five qubits, does not require a teleportation service, and requires a silicon qubit material.

In this example assume that the selection rules 44-1, 44-3 and 44-4 are disabled and the selection rule 44-2 is enabled. The selection rule 44-2 is a best fit selection rule. In response to determining that the selection rule 44-2 is enabled the controller 30 obtains the QCS information 32 associated with the plurality of QCSs 22 and the quantum simulator profile information 42.

Based on the information, the controller 30 determines that the QCS profile 35-N most closely matches the computing resource needs of the quantum workload 56, and makes a determination to cause the initiation of the quantum workload 56 on a QCS 22. The closest match determination may be any suitable algorithm, such as a constraint based algorithm or the like, that factors in the requirements of the quantum workload 56 and the characteristics of the QCSs 22 as identified by the QCS profiles 35 and the characteristics of the quantum simulation profiles 43.

The controller 30 causes a quantum process 60 to be initiated on the QCS 22-N based on the information associated with the quantum workload 56 and the QCS profile 35-N. The controller 30 may send the quantum workload 56 to the QCS 22-N and instruct the QCS 22-N to initiate the quantum process 60 from the quantum workload 56.

After the quantum process 60 terminates, the results of the quantum process 60 may be stored in a predetermined location and subsequently accessed by the computing device 26.

Referring now to FIG. 1D, another example of dynamic computer selection for quantum workload execution will be discussed. In this example, the user 46 of the computing device 26 causes the computing device 26 to send a request 61 comprising a quantum workload 62 to the computing system 12 for initiation on a QCS 22 or initiation in a quantum simulator that is initiated on a computing system 24. The quantum workload 62 includes, or is accompanied by, metadata 64 that comprises information about the quantum workload 62. The computing system 12 receives the quantum workload 62 and the metadata 64. The controller 30 obtains information about the request 61. Again, the information can comprise the metadata 64, and/or the information can comprise information contained in the quantum workload 62. For example, the quantum workload 62 may comprise a QIF, and the controller 30 may parse the QIF to determine computing resource needs of the QIF. In this example, assume that the information indicates that the quantum workload requires twenty qubits, does not require a teleportation service, and requires a photonic qubit material.

In this example assume that the selection rules 44-1, 44-2 and 44-4 are disabled and the selection rule 44-3 is enabled. The selection rule 44-3 is a fastest initiation rule. In response to determining that the selection rule 44-3 is enabled the controller 30 polls each of the QCSs 22 to obtain the real time resource information 33. The controller 30 may also poll each of the computing systems 24 to obtain the real time resource information 38. Based on the real time resource information 33 and the real time resource information 38, the controller 30 determines that the computing system 24-Z is capable of executing the quantum workload 62 prior to any QCS 22 or any other computing system 24. For example, the computing system 24-Z may have a lowest queue depth of tasks awaiting execution.

The controller 30 may then access the quantum simulator profiles 43-1 – 43-X to determine a closest matching configuration of computing resource needs of the quantum workload 62 compared to the computing resource characteristics identified in the quantum simulator profiles 43-1 – 43-X. In this example the controller 30 determines that the quantum simulator profile 43-X most closely matches the computing resource needs of the quantum workload 62. The controller 30 causes a quantum simulator 66 to be initiated on the classical computing system 24-Z and causes the quantum workload 62 to be initiated as a quantum process 68 in the quantum simulator 52. The controller 30 may instruct the computing system 24-Z, based on the quantum simulator profile 43-X, to initiate the quantum simulator 66 to have 24 qubits, a parity error correction algorithm, a teleportation service, and a photonic qubit material type. The controller 30 may send the quantum workload 62 to the computing system 24-Z for initiation in the quantum simulator 66.

After the quantum process 68 terminates, the computing system 24-Z terminates the quantum simulator 66. The results of the quantum simulation may be stored in a predetermined location and subsequently accessed by the computing device 26.

Referring now to FIG. 1E, another example of dynamic computer selection for quantum workload execution will be discussed. In this example, the user 46 of the computing device 26 causes the computing device 26 to send a request 69 comprising a quantum workload 70 to the computing system 12 for initiation on a QCS 22 or initiation in a quantum simulator that is initiated on a computing system 24. The quantum workload 70 includes, or is accompanied by, metadata 72 that comprises information about the quantum workload 70. The computing system 12 receives the quantum workload 70 and the metadata 72. The controller 30 obtains information about the request 69. Again, the information can comprise the metadata 72, and/or the information can comprise information contained in the quantum workload 70.

In this example assume that the selection rules 44-1, 44-2 and 44-3 are disabled and the selection rule 44-4 is enabled. The selection rule 44-4 is a load balancing rule. In response to determining that the selection rule 44-4 is enabled the controller 30 utilizes a load-balancing algorithm to determine where to cause the initiation of the quantum workload 70. Any suitable load-balancing algorithm may be utilized, such as, by way of non-limiting example, a round-robin load-balancing algorithm, an IP hash load-balancing algorithm, or the like. Based on the load-balancing algorithm, the controller determines that the quantum workload 70 is to be initiated on the QCS 22-1. The controller 30 causes a quantum process 74 to be initiated on the QCS 22-1 based on the quantum workload 70. The controller 30 may send the quantum workload 70 to the QCS 22-1 and instruct the QCS 22-1 to initiate the quantum process 74 from the quantum workload 70. After the quantum process 74 terminates, the results of the quantum process 74 may be stored in a predetermined location and subsequently accessed by the computing device 26.

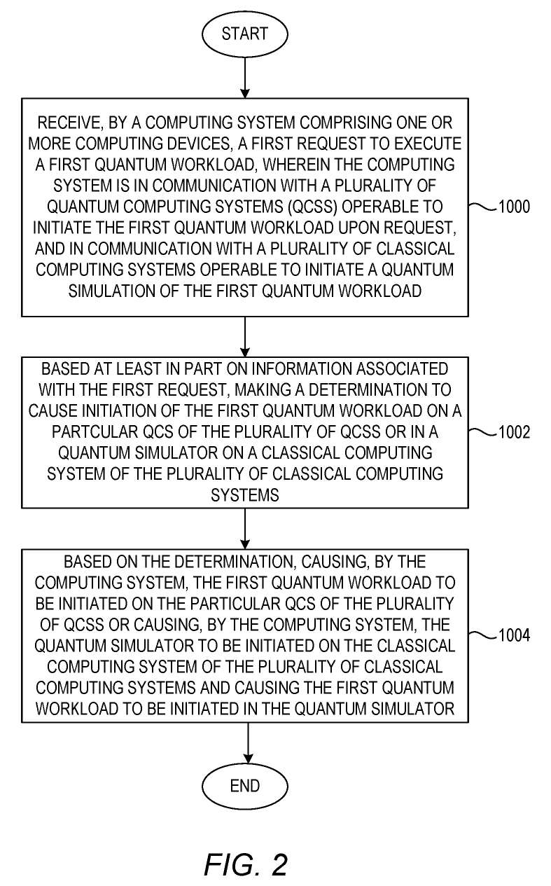

FIG. 2 is a flowchart of a method for dynamic computer selection for quantum workload execution according to some examples. FIG. 2 will be discussed in conjunction with FIGS. 1A and 1B. The computing system 12 receives the request 47 to execute the quantum workload 48, wherein the computing system 12 is in communication with the plurality of QCSs 22 operable to initiate a quantum workload upon request, and in communication with the plurality of classical computing systems 24 operable to initiate a quantum simulation of a quantum workload (FIG. 2, block 1000). Based at least in part on information associated with the request 47, the computing system 12 makes a determination to cause the initiation of the quantum workload 48 on a particular QCS 22 of the plurality of QCSs 22 or in a quantum simulator on a classical computing system 24 of the plurality of classical computing systems 24 (FIG. 2, block 1002). Based on the determination, the computing system 12 causes the quantum workload 47 to be initiated on the particular QCS 22 of the plurality of QCSs 22 or causes the quantum simulator to be initiated on the classical computing system 24 of the plurality of classical computing systems 24 and causes the quantum workload 47 to be initiated in the quantum simulator (FIG. 2, block 1004).

The computing system 12 obtains information associated with the first request (FIG. 2, block 1002). The computing system 12, based at least in part on the information associated with the request 47, makes a determination to cause the initiation of the quantum workload 48 on a QCS 22 of the plurality of QCSs 22 or in a quantum simulator on a classical computing system 24 of the plurality of classical computing systems 24 (FIG. 2, block 1004). The computing system 12, based on the determination, causes the quantum workload 48 to be initiated on a particular QCS 22 of the plurality of QCSs 22 or causes a quantum simulator to be initiated on a classical computing system 24 of the plurality of classical computing systems 24 and causes the quantum workload 48 to be initiated in the quantum simulator (FIG. 2, block 1006).

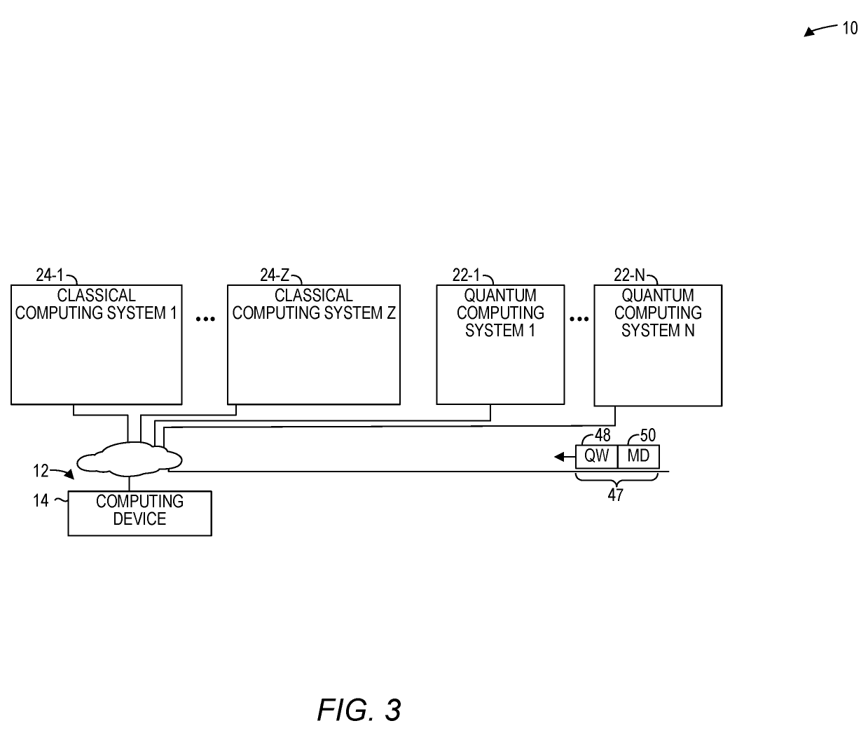

FIG. 3 is a simplified block diagram of the environment 10 illustrated in FIGS. 1A-1E according to some implementations. The environment 10 includes the computing system 12 that includes the one or more computing devices 14. The one or more computing devices 14 are to receive the request 47 to execute the quantum workload 48, wherein the computing system 12 is in communication with the plurality of QCSs 22 operable to initiate a quantum workload upon request, and in communication with the plurality of classical computing systems 24 operable to initiate a quantum simulation of a quantum workload. The one or more computing devices 14 are to, based at least in part on information associated with the request 47, make a determination to cause the initiation of the quantum workload 48 on a QCS 22 of the plurality of QCSs 22 or in a quantum simulator on a classical computing system 24 of the plurality of classical computing systems 24. The one or more computing devices 14 are to, based on the determination, cause the quantum workload 48 to be initiated on a particular QCS 22 of the plurality of QCSs 22 or cause a quantum simulator to be initiated on a classical computing system 24 of the plurality of classical computing systems 24 and cause the quantum workload 48 to be initiated in the quantum simulator.

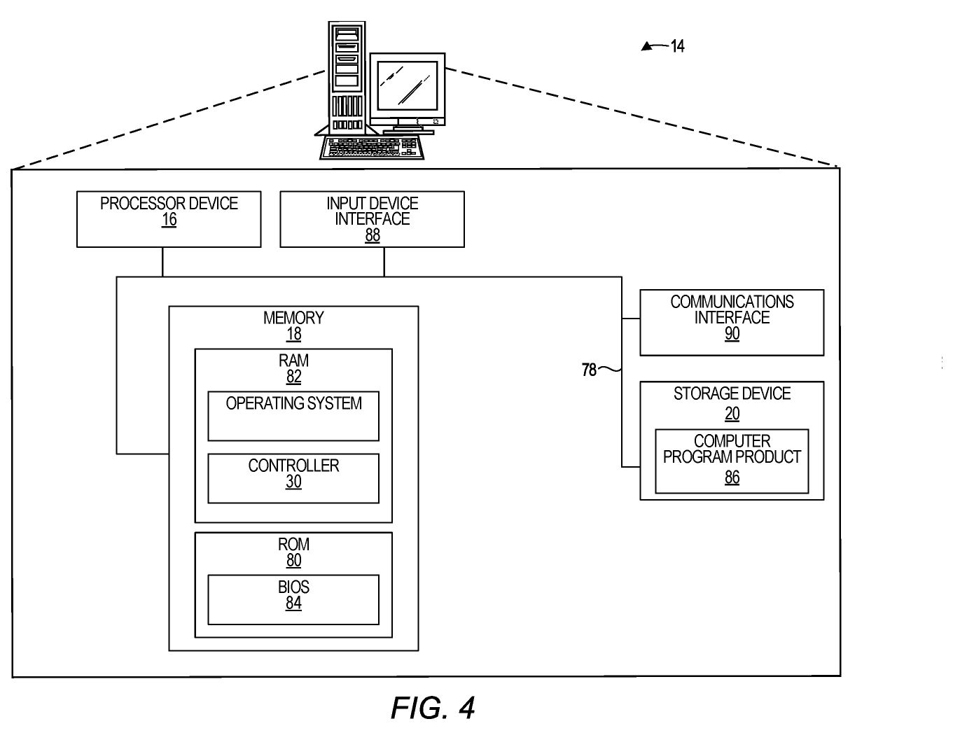

FIG. 4 is a block diagram of a computing device 14 suitable for implementing examples according to one example. The computing device 14 may comprise any computing or electronic device capable of including firmware, hardware, and/or executing software instructions to implement the functionality described herein, such as a computer server, a desktop computing device, a quantum computing device, or the like. The computing device 14 includes the processor device 16, the system memory 18, and a system bus 78. The system bus 78 provides an interface for system components including, but not limited to, the system memory 18 and the processor device 16. The processor device 16 can be any commercially available or proprietary processor.

The system bus 78 may be any of several types of bus structures that may further interconnect to a memory bus (with or without a memory controller), a peripheral bus, and/or a local bus using any of a variety of commercially available bus architectures. The system memory 18 may include non-volatile memory 80 (e.g., read-only memory (ROM), erasable programmable read-only memory (EPROM), electrically erasable programmable read-only memory (EEPROM), etc.), and volatile memory 82 (e.g., random-access memory (RAM)). A basic input/output system (BIOS) 84 may be stored in the non-volatile memory 80 and can include the basic routines that help to transfer information between elements within the computing device 14. The volatile memory 82 may also include a high-speed RAM, such as static RAM, for caching data.

The computing device 14 may further include or be coupled to a non-transitory computer-readable storage medium such as the storage device 20, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 20 and other drives associated with computer-readable media and computer-usable media may provide non-volatile storage of data, data structures, computer-executable instructions, and the like.

A number of modules can be stored in the storage device 20 and in the volatile memory 82, including an operating system and one or more program modules, such as the controller 30, which may implement the functionality described herein in whole or in part. All or a portion of the examples may be implemented as a computer program product 86 stored on a transitory or non-transitory computer-usable or computer-readable storage medium, such as the storage device 20, which includes complex programming instructions, such as complex computer-readable program code, to cause the processor device 16 to carry out the steps described herein. Thus, the computer-readable program code can comprise software instructions for implementing the functionality of the examples described herein when executed on the processor device 16. The processor device 16, in conjunction with the controller 30 in the volatile memory 82, may serve as a controller, or control system, for the computing device 14 that is to implement the functionality described herein.

An operator may also be able to enter one or more configuration commands through a keyboard (not illustrated), a pointing device such as a mouse (not illustrated), or a touch-sensitive surface such as a display device. Such input devices may be connected to the processor device 16 through an input device interface 88 that is coupled to the system bus 78 but can be connected by other interfaces such as a parallel port, an Institute of Electrical and Electronic Engineers (IEEE) 1394 serial port, a Universal Serial Bus (USB) port, an IR interface, and the like. The computing device 14 may also include a communications interface 90, such as an Ethernet transceiver or the like, suitable for communicating with a network as appropriate or desired.

Individuals will recognize improvements and modifications to the preferred examples of the disclosure. All such improvements and modifications are considered within the scope of the concepts disclosed herein and the claims that follow.

What is claimed is:

1. A method, comprising:
receiving, by a computing system comprising one or more computing devices, a first request to execute a first quantum workload, wherein the computing system is in communication with a plurality of quantum computing systems (QCSs) operable to initiate the first quantum workload upon request, and in communication with a plurality of classical computing systems operable to initiate a quantum simulation of the first quantum workload;
based at least in part on information associated with the first request, making a determination to cause initiation of the first quantum workload on a particular QCS of the plurality of QCSs or in a quantum simulator on a classical computing system of the plurality of classical computing systems; and
based on the determination, causing, by the computing system, the first quantum workload to be initiated on the particular QCS of the plurality of QCSs or causing, by the computing system, the quantum simulator to be initiated on the classical computing system of the plurality of classical computing systems and causing the first quantum workload to be initiated in the quantum simulator.

2. The method of claim 1, further comprising:
obtaining QCS information associated with the plurality of QCSs, the QCS information identifying one or more of real time resource information about the plurality of QCSs or QCS configuration information that identifies characteristics of the plurality of QCSs; and
obtaining quantum simulator profile information associated with a plurality of corresponding quantum simulator profiles, each respective quantum simulator profile identifying quantum computer resource characteristics of a quantum simulator initiated based on the respective quantum simulator profile; and
wherein making the determination to cause the initiation of the first quantum workload on the particular QCS of the plurality of QCSs or in the quantum simulator on the classical computing system of the plurality of classical computing systems is further based on the QCS information and the quantum simulator profile information.

3. The method of claim 2, further comprising:
accessing a selection rule; and
wherein making the determination to cause the initiation of the first quantum workload on the particular QCS of the plurality of QCSs or in the quantum simulator on the classical computing system of the plurality of classical computing systems is further based at least in part on the selection rule.

4. The method of claim 3, wherein the selection rule is a best fit selection rule indicating that the first quantum workload is to be initiated on the particular QCS of the plurality of QCSs or simulated in the quantum simulator on the classical computing system of the plurality of classical computing systems based on a closest matching configuration of computing resource needs of the first quantum workload compared to the characteristics of the plurality of QCSs and the quantum computer resource characteristics identified in the plurality of quantum simulator profiles.

5. The method of claim 3, wherein the selection rule is a fastest initiation selection rule indicating that the first quantum workload is to be initiated on the particular QCS of the plurality of QCSs or simulated in the quantum simulator on the classical computing system of the plurality of classical computing systems based on where the first quantum workload can be executed first.

6. The method of claim 2, wherein making the determination to cause the initiation of the first quantum workload on the particular QCS of the plurality of QCSs or in the quantum simulator on the classical computing system of the plurality of classical computing systems further comprises:
determining that the information associated with the first request identifies a characteristic of a quantum computing system necessary for the first quantum workload to execute;
based on the QCS information, determining that no QCS of the plurality of QCSs has the characteristic of the quantum computing system necessary for the first quantum workload to execute;
based on the quantum simulator profile information, determining that a first quantum simulator profile includes the characteristic of the quantum computing system necessary for the first quantum workload to execute; and
in response to determining that the first quantum simulator profile includes the characteristic of the quantum computing system necessary for the first quantum workload to execute, making the determination to cause the initiation of the first quantum workload in the quantum simulator on the classical computing system of the plurality of classical computing systems.

7. The method of claim 1, further comprising:
accessing a selection rule; and
wherein making the determination to cause the initiation of the first quantum workload on the particular QCS of the plurality of QCSs or in the quantum simulator on the classical computing system of the plurality of classical computing systems is further based at least in part on the selection rule.

8. The method of claim 1, wherein, based at least in part on the information associated with the first request, making the determination to cause the initiation of the first quantum workload on the particular QCS of the plurality of QCSs or in the quantum simulator on the classical computing system of the plurality of classical computing systems further comprises:
determining, based on the information associated with the first request, that the first quantum workload has a status other than a production status; and
in response to determining that the first quantum workload has the status other than the production status, making the determination to cause the initiation of the first quantum workload in the quantum simulator on the classical computing system of the plurality of classical computing systems.

9. The method of claim 1, wherein, based at least in part on the information associated with the first request, making the determination to cause the initiation of the first quantum workload on the particular QCS of the plurality of QCSs or in the quantum simulator on the classical computing system of the plurality of classical computing systems further comprises:
determining that the information associated with the first request identifies a characteristic of a quantum computing system necessary for the first quantum workload to execute;
determining that the particular QCS has the characteristic of the quantum computing system necessary for the first quantum workload to execute; and
in response to determining that the particular QCS has the characteristic of the quantum computing system necessary for the first quantum workload to execute, making the determination to cause the initiation of the first quantum workload on the particular QCS of the plurality of QCSs.

10. The method of claim 9, wherein the characteristic comprises at least one of a quantity of qubits or a type of qubit.

11. The method of claim 1, wherein, based at least in part on the information associated with the first request, making the determination to cause the initiation of the first quantum workload on the particular QCS of the plurality of QCSs or in the quantum simulator on the classical computing system of the plurality of classical computing systems further comprises:
based at least in part on the information associated with the first request, causing, by the computing system, the first quantum workload to be initiated on the particular QCS of the plurality of QCSs; and further comprising:
receiving, by the computing system, a second request to execute a second quantum workload;
obtaining information associated with the second request; and
based at least in part on the information associated with the second request, causing, by the computing system, the quantum simulator to be initiated on the classical computing system of the plurality of classical computing systems and causing the second quantum workload to be initiated in the quantum simulator.

12. A computing system comprising:
one or more computing devices to:
receive a first request to execute a first quantum workload, wherein the computing system is in communication with a plurality of quantum computing systems (QCSs) operable to initiate the first quantum workload upon request, and in communication with a plurality of classical computing systems operable to initiate a quantum simulation of the first quantum workload;
based at least in part on information associated with the first request, make a determination to cause initiation of the first quantum workload on a particular QCS of the plurality of QCSs or in a quantum simulator on a classical computing system of the plurality of classical computing systems; and
based on the determination, cause the first quantum workload to be initiated on the particular QCS of the plurality of QCSs or cause the quantum simulator to be initiated on the classical computing system of the plurality of classical computing systems and cause the first quantum workload to be initiated in the quantum simulator.

13. The computing system of claim 12, wherein the one or more computing devices are further to:
obtain QCS information associated with the plurality of QCSs, the QCS information identifying one or more of real time resource information about the plurality of QCSs or QCS configuration information that identifies characteristics of the plurality of QCSs;
obtain quantum simulator profile information associated with a plurality of corresponding quantum simulator profiles, each respective quantum simulator profile identifying quantum computer resource characteristics of a quantum simulator initiated based on the respective quantum simulator profile; and
wherein the determination to cause the initiation of the first quantum workload on the particular QCS of the plurality of QCSs or in the quantum simulator on the classical computing system of the plurality of classical computing systems is further based on the QCS information and the quantum simulator profile information.

14. The computing system of claim 13, wherein the one or more computing devices are further to:
access a selection rule; and
wherein the determination to cause the initiation of the first quantum workload on the particular QCS of the plurality of QCSs or in the quantum simulator on the classical computing system of the plurality of classical computing systems is further based at least in part on the selection rule.

15. The computing system of claim 12, wherein to, based at least in part on the information associated with the first request, make the determination to cause the initiation of the first quantum workload on the particular QCS of the plurality of QCSs or in the quantum simulator on the classical computing system of the plurality of classical computing systems, the one or more computing devices are further to:
determine that the information associated with the first request identifies a characteristic of a quantum computing system necessary for the first quantum workload to execute;
determine that the particular QCS has the characteristic of the quantum computing system necessary for the first quantum workload to execute; and
in response to determining that the particular QCS has the characteristic of the quantum computing system necessary for the first quantum workload to execute, make the determination to cause the initiation of the first quantum workload on the particular QCS of the plurality of QCSs.

16. The computing system of claim 12, wherein to, based at least in part on the information associated with the first request, making the determination to cause the initiation of the first quantum workload on the particular QCS of the plurality of QCSs or in the quantum simulator on the classical computing system of the plurality of classical computing systems, the one or more computing devices are further to:
based at least in part on the information associated with the first request, cause, by the computing system, the first quantum workload to be initiated on the particular QCS of the plurality of QCSs; and
wherein the one or more computing devices are further to:
receive a second request to execute a second quantum workload;
obtain information associated with the second request; and
based at least in part on the information associated with the second request, cause the quantum simulator to be initiated on the classical computing system of the plurality of classical computing systems and cause the second quantum workload to be initiated in the quantum simulator.

17. A non-transitory computer-readable storage medium that includes executable instructions to cause a computing system to:
receive a first request to execute a first quantum workload, wherein the computing system is in communication with a plurality of quantum computing systems (QCSs) operable to initiate the first quantum workload upon request, and in communication with a plurality of classical computing systems operable to initiate a quantum simulation of the first quantum workload;
based at least in part on information associated with the first request, make a determination to cause initiation of the first quantum workload on a particular QCS of the plurality of QCSs or in a quantum simulator on a classical computing system of the plurality of classical computing systems; and
based on the determination, cause the first quantum workload to be initiated on the particular QCS of the plurality of QCSs or cause the quantum simulator to be initiated on the classical computing system of the plurality of classical computing systems and cause the first quantum workload to be initiated in the quantum simulator.

18. The non-transitory computer-readable storage medium of claim 17, wherein the instructions are further to cause the computing system to:
obtain QCS information associated with the plurality of QCSs, the QCS information identifying one or more of real time resource information about the plurality of QCSs or QCS configuration information that identifies characteristics of the plurality of QCSs;
obtain quantum simulator profile information associated with a plurality of corresponding quantum simulator profiles, each respective quantum simulator profile identifying quantum computer resource characteristics of a quantum simulator initiated based on the respective quantum simulator profile; and
wherein the determination to cause the initiation of the first quantum workload on the particular QCS of the plurality of QCSs or in the quantum simulator on the classical computing system of the plurality of classical computing systems is further based on the QCS information and the quantum simulator profile information.

19. The non-transitory computer-readable storage medium of claim 18, wherein the instructions are further to cause the computing system to:
access a selection rule; and
wherein the determination to cause the initiation of the first quantum workload on the particular QCS of the plurality of QCSs or in the quantum simulator on the classical computing system of the plurality of classical is further based at least in part on the selection rule.

20. The non-transitory computer-readable storage medium of claim 17, wherein to, based at least in part on the information associated with the first request, make the determination to cause the initiation of the first quantum workload on the particular QCS of the plurality of QCSs or in the quantum simulator on the classical computing system of the plurality of classical computing systems, the instructions are further to cause the computing system to:
determine that the information associated with the first request identifies a characteristic of a quantum computing system necessary for the first quantum workload to execute;
determine that the particular QCS has the characteristic of the quantum computing system necessary for the first quantum workload to execute; and
in response to determining that the particular QCS has the characteristic of the quantum computing system necessary for the first quantum workload to execute, make the determination to cause the initiation of the first quantum workload on the particular QCS of the plurality of QCSs.
